(19) United States
(12) Patent Application Publication
(10) Pub. No.: US 2021/0158540 A1
(43) Pub. Date: May 27, 2021

(54) NEURAL NETWORK BASED IDENTIFICATION OF MOVING OBJECT

(71) Applicant: SONY CORPORATION, Tokyo (JP)

(72) Inventors: Hirofumi HIBI, Tokyo (JP); Hiroaki NISHIMURA, Paramus, NJ (US); Nikolaos GEORGIS, San Diego, CA (US)

(21) Appl. No.: 16/690,365

(22) Filed: Nov. 21, 2019

(51) Int. Cl. G06T 7/215; G06T 7/246; G06T 7/223; G06T 7/11; G06K 9/62; G06K 9/32; G06N 3/04

(52) U.S. Cl. CPC G06T 7/215; G06T 7/246; G06T 7/223; G06T 7/11; G06T 2207/10004; G06K 9/325; G06N 3/0454; G06T 2207/30248; G06K 9/6256

(57) ABSTRACT

An electronic device includes circuitry that receives first identification information of a moving object from the moving object. A sub-image is detected from an image of the moving object based on application of a first neural network model on the image. The sub-image includes second identification information of the moving object. The first neural network model is trained to detect a moving object based on one or more first images corresponding to one or more moving objects. The second identification information is extracted from the sub-image based on application of a second neural network model on the sub-image. The second neural network model is trained to determine text information based one or more second images corresponding to text information. The first identification information is compared with the second identification information. The moving object is identified based on the comparison. Thereafter, the moving object is controlled based on the identification.

### CROSS-REFERENCE TO RELATED APPLICATIONS/INCORPORATION BY REFERENCE

None.

### FIELD

Various embodiments of the disclosure relate to a moving object identification. More specifically, various embodiments of the disclosure relate to a neural network based identification of a moving object.

### BACKGROUND

Recent advancements in the field of object identification have led to development of various technologies to recognize moving objects, such as, aircrafts or vehicles. Typically, the moving objects (such as aircrafts) broadcast information (for example, call signs, recent position, and altitude) to a traffic system and/or controller (such as an air traffic control or ATC) or to other moving objects. The traffic controller normally recognizes the moving objects (say, during landing or takeoff of aircrafts) based on the broadcasted information received at a set interval (say in every few seconds) from the moving object. However, due to rapid increase in the movement of multiple moving objects within short durations (for example parallel landings or takeoffs of the aircrafts), it may be difficult for the traffic controller to uniquely recognize the moving objects based on the information (such as call signs) received from the moving objects. In such situation, the time interval set by the multiple moving objects for the broadcasting of the information may not be sufficient enough for the traffic controller to accurately recognize the moving objects (such as aircrafts). Thus, the accuracy of the recognition of the moving objects may reduce, which may further affect communication between the moving objects and the traffic controller.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An apparatus and a method for a neural network based identification of a moving object, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary environment for a neural network based identification of a moving object, in accordance with an embodiment of the disclosure.

FIG. 2 is a block diagram that illustrates an exemplary electronic device for a neural network based identification of a moving object, in accordance with an embodiment of the disclosure.

FIG. 3 is a diagram that illustrates an exemplary scenario for implementation of the electronic device of FIG. 2 for a neural network based identification of a moving object, in accordance with an embodiment of the disclosure.

FIG. 4 depicts a flowchart that illustrates an exemplary method for a neural network based identification of a moving object, in accordance with an embodiment of the disclosure.

### DETAILED DESCRIPTION

Various embodiments of the present disclosure may be found in an electronic device and a method for accurate identification of a moving object based on a neural network model. The electronic device may be configured to receive first identification information (for example call sign or unique identifier) of a moving object (such as aircrafts or land vehicles like cars) from the moving object. The first identification may be received from the moving vehicle, for example, at a time of arrival towards or departure away from the electronic apparatus. The electronic apparatus may further control an image capturing device (such as camera) to capture an image of the moving object. The electronic device may be further configured to detect second identification information of the moving object based on application of one or more neural network models on the captured image. The second identification information may be a unique identifier (for example a tail number of the aircraft) of the moving object which may be printed or painted on an outer surface of the moving object. The electronic device may be configured to compare the detected second identification information with the received first identification information, and identify the moving object based on the comparison. Further, the electronic device may control the moving object based on the identification. The identification or recognition of the moving object on a run-time basis based on the combined consideration (i.e. multi-modal) of the second identification information included in the captured image and the first identification information received from the moving object may improve the accuracy of the identification of the moving object in different situations (for example, even when frequency of movement of multiple moving vehicles around the electronic device is high).

In accordance with an embodiment, the electronic device may be further configured to update or re-train the one or more neural network models based on the comparison of the first identification information with the second identification information, and the identification of the moving object. The re-trained neural network models may further enhance the accuracy of the identification/recognition of the moving object performed by the disclosed electronic apparatus.

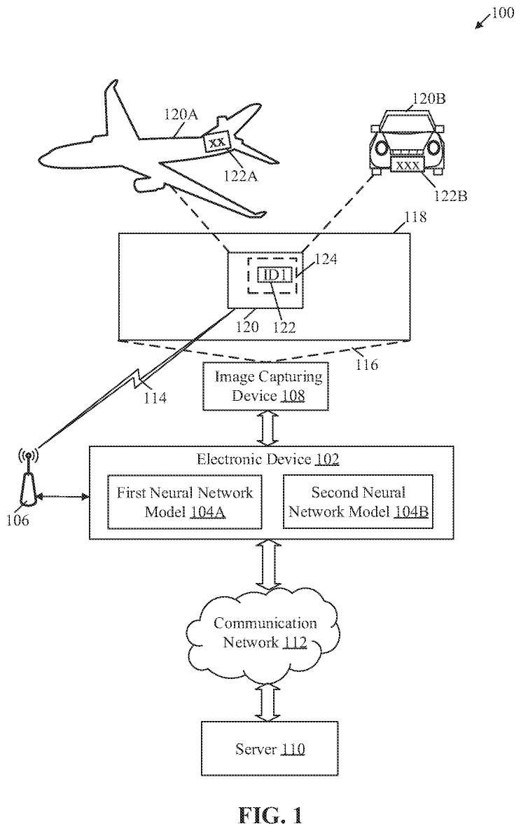

FIG. 1 is a block diagram that illustrates an exemplary environment for a neural network based identification of a moving object, in accordance with an embodiment of the disclosure. With reference to FIG. 1, there is shown a network environment 100, which may include an electronic device 102, a wireless receiver device 106, an image capturing device 108, a server 110, and a communication network 112. The electronic device 102 may further include a first neural network model 104A and a second neural network model 104B. In some embodiments, the electronic device 102 may be communicatively coupled to the image capturing device 108. In other embodiments, the image capturing device 108 may be integrated with the electronic device 102. Further, in some embodiments, the electronic device 102 may be communicatively coupled to the wireless receiver device 106. In other embodiments, the wireless receiver device 106 may be integrated with the electronic device 102. The electronic device 102 may be communicatively coupled to the server 110, via the communication network 112. In FIG. 1, there is also shown a field of view (FOV) 116 of the image capturing device 108 and an image 118 that may be captured by the image capturing device 108 based on the FOV 116 of the image capturing device 108. The image 118 may be of a moving object, such as a moving object 120. The wireless receiver device 106 may communicate with the moving object 120 via a wireless communication link 114 as shown in FIG. 1. Examples of the moving object 120 may include an aircraft (such as an aircraft 120A) or a vehicle (such as a vehicle 120B). In FIG. 1 there is further shown, that the image 118 may include a sub-image 124 of the moving object 120. The sub-image 124 may include identification information of the moving object 120, such as an object identifier 122 (e.g., “ID1” as shown in FIG. 1) of the moving object 120. For instance, the object identifier 122 may correspond to a registration number 122A (or a tail number) of the aircraft 120A or a license plate number 122B of the vehicle 120B (such as, but not limited to, a car, a bus, a motorcycle or other wheeled motor vehicle). It should be noted that the moving object 120 (such as the aircraft 120A and the vehicle 120B) shown in FIG. 1 is presented merely as an example of a moving object. The present disclosure may be also applicable to other types of moving objects. A description of other types of moving objects has been omitted from the disclosure for the sake of brevity.

The electronic device 102 may include suitable logic, circuitry, interfaces, and/or code that may be configured to identify a moving object (such as the moving object 120) based on one or more neural network models. The electronic device 102 may be configured to receive first identification information of the moving object 120 from the moving object 120, via the wireless receiver device 106. The electronic device 102 may be configured to control the image capturing device 108 to capture the image 118 of the moving object 120. The electronic device 102 may be further configured to detect the sub-image 124 of the moving object 120 from the image 118 based on an application of the first neural network model 104A on the image 118. The sub-image 124 may include second identification information (i.e. object identifier 122) of the moving object 120. For instance, in case the moving object 120 corresponds to the aircraft 120A, the second identification information may correspond to the registration number 122A. In such case, the sub-image 124 may include a tail portion of the aircraft 120A that may include the registration number 122A or the tail number. Further, in case the moving object 120 corresponds to the vehicle 120B, the second identification information may correspond to the license plate number 122B. In such case, the sub-image 124 may include a number plate region (such as, the license plate number 122B of the vehicle 120B). The electronic device 102 may be further configured to extract the second identification information of the moving object 120 from the sub-image 124 based on an application of the second neural network model 104B on the sub-image 124. The electronic device 102 may compare the first identification information with the second identification information and identify the moving object 120 based on the comparison. Thereafter, the electronic device 102 may control the moving object 120 based on the identification of the moving object 120. The control of the moving object 120 may correspond to control of the communication with the moving object 120. Examples of the electronic device 102 may include, but are not limited to an airplane tracker device, an Automatic License Plate Recognition (ALPR) device, an air-traffic controller device, a vehicle surveillance device, a handheld computer, a computer workstation, a cellular/mobile phone, a tablet computing device, a Personal Computer (PC), a mainframe machine, a consumer electronic (CE) device, and other computing devices.

In one or more embodiments, each of the first neural network model 104A and the second neural network model 104B may include electronic data, such as, for example, a software program, code of the software program, libraries, applications, scripts, or other logic or instructions for execution by a processing device, such as a processor of the electronic device 102. Each of the first neural network model 104A and the second neural network model 104B may include code and routines configured to enable a computing device, such as the processor of the electronic device 102, to perform one or more operations. The one or more operations of the first neural network model 104A may include classification of each pixel of an image (e.g., the image 118) into one of a true description or a false description associated with a moving object (e.g., the moving object 120). Further, the one or more operations of the second neural network model 104B may include classification of each pixel of a sub-image (e.g., the sub-image 124 of the image 118) into one of a true description or a false description associated with an alphanumeric textual character included in the sub-image. Additionally, or alternatively, each of the first neural network model 104A and the second neural network model 104B may be implemented using hardware including a processor, a microprocessor (e.g., to perform or control performance of one or more operations), a field-programmable gate array (FPGA), or an application-specific integrated circuit (ASIC). In some other instances, the neural network model 104 may be implemented using a combination of hardware and software.

Examples of the first neural network model 104A may include, but are not limited to, an artificial neural network (ANN), a convolutional neural network (CNN), a CNN-recurrent neural network (CNN-RNN), Region-CNN (R-CNN), Fast R-CNN, Faster R-CNN, a Long Short Term Memory (LSTM) network based RNN, a combination of CNN and ANN, a combination of LSTM and ANN, a gated recurrent unit (GRU)-based RNN, a deep Bayesian neural network, a Generative Adversarial Network (GAN), a deep learning based object detection model, a feature-based object detection model, an image segmentation based object detection model, a blob analysis-based object detection model, a “you look only once” (YOLO) object detection model, or a single-shot multi-box detector (SSD) based object detection model. Examples of the second neural network model 104B may include, but are not limited to, a connectionist-temporal-classification (CTC)-based deep neural network (DNN) model. In accordance with an embodiment, the CTC-based DNN model may be a combination of a convolutional neural network (CNN) model and a long-short term memory (LSTM)-based recurrent neural network (RNN) model trained based on a CTC model.

The wireless receiver device 106 may include suitable logic, circuitry, interfaces, and/or code that may be configured to communicate with the moving object 120, via the wireless communication link 114. The wireless receiver device 106 may be configured to receive the first identification information of the moving object 120 from the moving object 120 at regular intervals (say in every few seconds). Further, the wireless receiver device 106 may be configured to communicate the received first identification information to the electronic device 102. In some embodiments, the wireless receiver device 106 may receive instructions or commands from the electronic device 102 and may send the received instructions or commands to the moving object 120. The electronic device 102 may control communication with the moving object 120, through the wireless receiver device 106. In some embodiments, the wireless receiver device 106 may be integrated with the electronic device 102. In case where the moving object 120 corresponds to the vehicle 120B, the wireless receiver device 106 may correspond to, but is not limited to, a wireless transceiver, an antenna system, or a radio frequency (RF) transceiver which may be associated with a vehicle traffic monitoring authority, a traffic regulatory authority, a law enforcement authority, a traffic police authority. In case where the moving object 120 corresponds to the aircraft 120A, the wireless receiver device 106 may correspond to, but is not limited to, a wireless ground station transceiver, an antenna system, or radio frequency (RF) transceiver associated with an air-traffic controller, a particular airline, or an airport authority.

The image capturing device 108 may include suitable logic, circuitry, interfaces, and/or code that may be configured to capture one or more image frames, such as, the image 118 of the moving object 120. Examples of the image frame may include, but are not limited to, a High Dynamic Range (HDR) images, a Low Dynamic Range (LDR) image, a High Definition (HD) image, a 4K image, a RAW image, or images or video in other formats known in the art. The image capturing device 108 may be configured to communicate the captured image frames (e.g., the image 118) as input to the electronic device 102 for further processing (for example extraction of sub-image or identification of the moving object 120). The image capturing device 108 may be controlled by the electronic device 102 to capture the image 118 of the moving object 120 based on the receipt of the first identification information from the moving object 120. In some embodiments, the electronic device 102 may control the image capturing device 108 to capture the image 118 of the moving object 120 at regular interval (say in every few seconds or micro-seconds). The image capturing device 108 may be configured to control the FOV 116 based on control instructions or commands received from the electronic device 102. The image capturing device 108 may control its orientation, position (in a two-dimensional space or a three-dimensional space), or directions to control the FOV 116 so that the image capturing device 108 may capture the image 118 of the moving object 120 in correct manner. In case of the moving object 120 as the aircraft 120A, the FOV 116 may be towards sky from/to where the aircraft 120A may arrive/depart, a runway of airport, or a ground area associated with the airport, to capture the image 118 of the aircraft 120A (moving towards or away from the image capturing device 108). In case of the moving object 120 as the vehicle 120B, the FOV 116 may be towards a road on which the vehicle 120B may be moving (either towards or away from the image capturing device 108). The image capturing device 108 may be implemented by use of a charge-coupled device (CCD) technology or complementary metal-oxide-semiconductor (CMOS) technology. Examples of the image capturing device 108 may include, but are not limited to, an image sensor, a wide angle camera, a driving camera, a 360 degree camera, a closed circuitry television (CCTV) camera, a stationary camera, an action-cam, a video camera, a camcorder, a digital camera, a camera phone, an angled camera, a time-of-flight camera (ToF camera), a night-vision camera, and/or other image capture devices. The image capturing device 108 may be implemented as an integrated unit of the electronic device 102 or as a separate device. For example, in case the moving object corresponds to a moving vehicle (e.g., the vehicle 120B), the image capturing device 108 may include a camera device that may be mounted on another vehicle that tracks the moving vehicle. Further, in case the moving object corresponds to a moving aircraft (e.g., the aircraft 120A), the image capturing device 108 may include a camera device associated with a ground station or air-traffic controller.

The server 110 may include suitable logic, circuitry, interfaces, and/or code that may be configured to train one or more neural network models, such as the first neural network model 104A or the second neural network model 104B. For example, the first neural network model 104A may be trained for detection of the aircraft 120A or aircraft tail portion (i.e. sub-image) detection, and the second neural network model 104B may be trained for the determination of the aircraft registration number (or tail number) from the detected aircraft tail portion. The trained neural network model(s) may then be deployed on the electronic device 102 for real-time or near real-time aircraft tracking and the aircraft registration number determination. In another example, the first neural network model 104A may be trained for vehicle license plate detection and the second neural network model 104B may be trained for determination of a vehicle license plate number from the detected vehicle license plate. The trained neural network model(s) may then be deployed on the electronic device 102 for real-time or near real-time vehicle tracking and vehicle license plate number determination.

In an embodiment, the server 110 may be configured to store and transmit hotlist information associated with a plurality of moving objects (including the moving object 120) to the electronic device 102. The hotlist information may include third identification information associated with the moving object 120. The server 110 may receive updated hotlist information from the electronic device 102 based on identification of the moving object 120. In some embodiments, the server 110 may be configured to store the capture image 118 of the moving object 120. Examples of the server 110 may include, but are not limited to, an application server, a cloud server, a web server, a database server, a file server, a mainframe server, or a combination thereof.

The communication network 112 may include a medium through which the electronic device 102 may communicate with the server 110 or the image capturing device 108 (though not shown connected to the electronic device 102, via the communication network 112 in FIG. 1). Examples of the communication network 112 may include, but are not limited to, the Internet, a cloud network, a Long Term Evolution (LTE) network, a Wireless Local Area Network (WLAN), a Local Area Network (LAN), a telephone line (POTS), or other wired or wireless network. Various devices in the network environment 100 may be configured to connect to the communication network 112, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

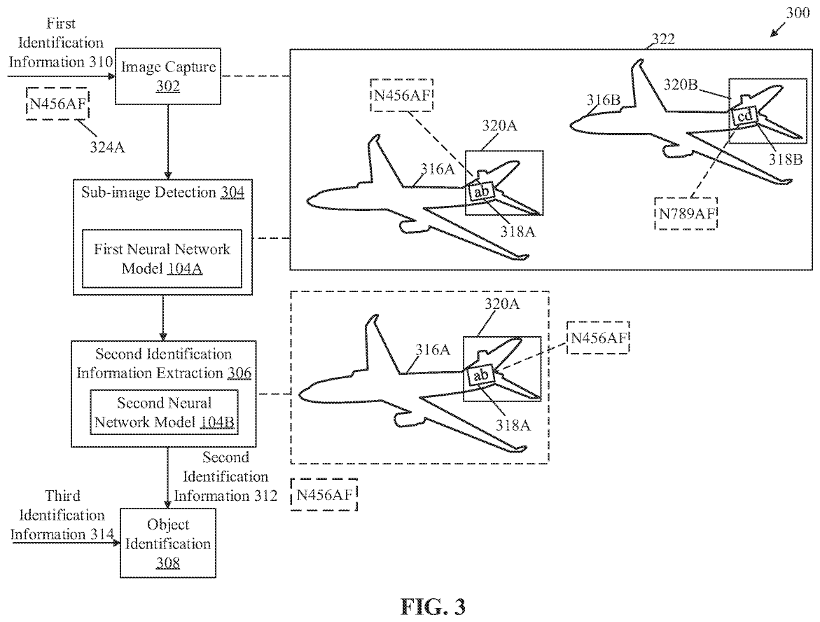

In operation, the electronic device 102 may be configured to receive the first identification information of the moving object 120 from the moving object 120, via the wireless receiver device 106. The first identification information may indicate a unique identity of the moving object 120. The moving object 120 may send the first identification information to the electronic device 102 based on a distance between the moving object 120 and the electronic device 102. In some embodiments, the wireless receiver device 106 may receive the first identification information from the moving object 120 at regular intervals (for example, in every few seconds), through the wireless communication link 114 based on the distance between the moving object 120 and the electronic device 102. The electronic device 102 may be configured to receive the first identification information from the wireless receiver device 106. For example, the electronic device 102 may receive the first identification information at first time information (e.g., once per second) based on the distance between the moving object 120 and the electronic device 102. The receipt of the first identification information is described, for example, in FIG. 3. The electronic device 102 may be further configured to control the image capturing device 108 to capture one or more image frames of the moving object 120 within the FOV 116 of the image capturing device 108. In one example, the image frames may be a live video (e.g., a video including the image 118) of the moving object such as the aircraft 120A that may be landing towards or taking off from a runway of an airport where the electronic device 102 may be deployed. In an embodiment, the image capturing device 108 may be situated, for example, close to the runway to capture one or more images of the aircraft 120A that may be landing or taking off. Examples of the aircraft 120A may include, but are not limited to, an airplane, a helicopter, an airship, a glider, a para-motor or a hot air balloon. In another example, the image frames may be a live video (including the image 118) of a road portion that may include a plurality of different moving objects, such as, the vehicle 120B. Examples of the vehicle 120B may include, but are not limited to, a car, a motorcycle, a truck, a bus, or other wheeled vehicles with license plates. In an embodiment, the image capturing device 108 may be situated close to the road portion to capture the image frames of the moving object, such as the vehicle 120B.

The electronic device 102 may be further configured to detect the sub-image 124 of the moving object 120 from the image 118 based on an application of the first neural network model 104A on the captured image 118. The first neural network model 104A may be pre-trained to detect the sub-image 124 from the captured image 118. Examples of the first neural network model 104A may include, but are not limited to, an artificial neural network (ANN), a convolutional neural network (CNN), a CNN-recurrent neural network (CNN-RNN), Region-CNN (R-CNN), Fast R-CNN, Faster R-CNN, a Long Short Term Memory (LSTM) network based RNN, a combination of CNN and ANN, a combination of LSTM and ANN, a gated recurrent unit (GRU)-based RNN, a deep Bayesian neural network, a Generative Adversarial Network (GAN), a deep learning based object detection model, a feature-based object detection model, an image segmentation based object detection model, a blob analysis-based object detection model, a “you look only once” (YOLO) object detection model, or a single-shot multi-box detector (SSD) based object detection model.

In accordance with an embodiment, the sub-image 124 may include the second identification information of the moving object 120. The second identification information may indicate a unique identity of the moving object 120 and may be printed or painted as an alphanumeric text on an outer surface of the moving object 120. In case of the moving object 120 as the aircraft 120A, the second identification information may be a tail number of the aircraft 120A. In another case where the moving object corresponds to the vehicle 120B, the second identification information may be a registration number of the vehicle printed on a license plate number of the vehicle 120B. The electronic device 102 may be further configured to extract the second identification information of the moving object 120 from the sub-image 124 based on an application of the second neural network model 104B on the sub-image 124. The second neural network model 104B may be pre-trained to detect textual information from an image (such as the sub-image 124 or the image 118). Examples of the second neural network model 104B may include, but are not limited to, a connectionist-temporal-classification (CTC)-based deep neural network (DNN) model. In accordance with an embodiment, the CTC-based DNN model may be a combination of a convolutional neural network (CNN) model and a long-short term memory (LSTM)-based recurrent neural network (RNN) model trained based on a CTC model. In some embodiments, the server 110 may be configured to train the first neural network model 104A and the second neural network model 104B and send the trained neural network models to the electronic device 102.

In accordance with an embodiment, the electronic device 102 may be further configured to compare the received first identification information with the extracted second identification information to identify or recognize the moving object 120 based on a result of the comparison. Further, the electronic device 102 may be further configured to control the moving object 120 based on the identification of the moving object 120. In accordance with an embodiment, the electronic device 102 may control communication with the moving object 120 based on the identification of the moving object 120. The identification of the moving object 120 based on the first neural network model 104A and the second neural network model 104B is described, for example, in FIG. 3.

According to embodiments of the present disclosure, the second identification information of the moving object 120 extracted from the sub-image 124 may be verified (or compared) with the first identification information of the moving object 120 received from the moving object 120. Thus, the disclosed electronic device 102 may identify or recognize the moving object 120 based on the combination of reception of the first identification information from the moving object 120 and the capture of the second identification information, which may be printed or painted on the outer surface of the moving object 120. The combination may provide an enhanced accuracy in the recognition of the moving object 120 even though multiple moving objects may be moving simultaneously towards or away from the electronic device 102 (or the image capturing device 108) or even the time interval at which the first identification information may be received by the electronic device 102 is higher.

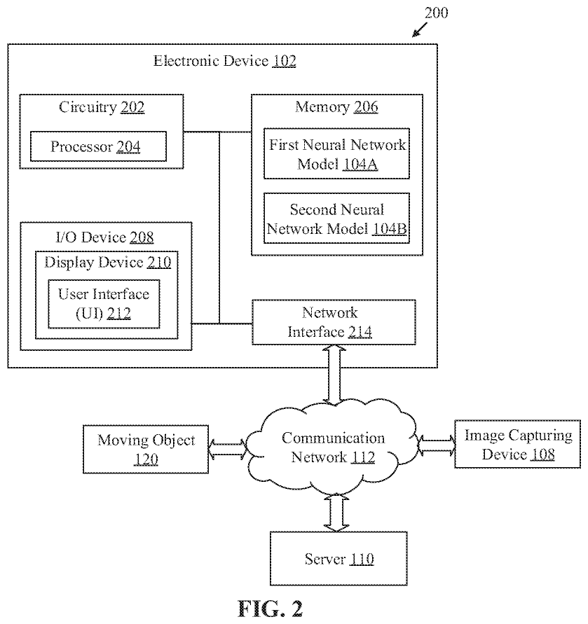

FIG. 2 is a block diagram that illustrates an exemplary electronic device for a neural network model based identification of a moving object, in accordance with an embodiment of the disclosure. FIG. 2 is explained in conjunction with elements from FIG. 1. With reference to FIG. 2, there is shown a block diagram 200 that depicts the electronic device 102. The electronic device 102 may include circuitry 202 that may include one or more processors, such as, a processor 204. The electronic device 102 may further include a memory 206, an input/output (I/O) device 208, and a network interface 214. The memory 206 may be configured to store the first neural network model 104A and the second neural network model 104B. In some embodiments, each of the first neural network model 104A and the second neural network model 104B may be a separate chip or circuitry to manage and implement one or more machine learning models. Further, the I/O device 208 of the electronic device 102 may include a display device 210 and a user interface (UI) 212. The network interface 214 may communicatively couple the electronic device 102 with the server 110, the image capturing device 108, or the moving object 120, via the communication network 112. In some embodiments, the electronic device 102 may also be communicatively coupled to the wireless receiver device 106, which may communicate with the moving object 120, via the wireless communication link 114.

The circuitry 202 may include suitable logic, circuitry, and interfaces that may be configured to execute program instructions associated with different operations to be executed by the electronic device 102. For example, some of the operations may include reception of the first identification information of the moving object 120 from the moving object 120, control of the image capturing device 108 to capture the image 118 of the moving object 120, and detection of the sub-image 124 of the moving object 120 from the image 118 based on application of the first neural network model 104A on the image 118. For example, some of the operations may further include extraction of the second identification information of the moving object 120 from the sub-image 124 based on the application of the second neural network model 104B on the sub-image 124, comparison of the first identification information with the second identification information, identification of the moving object 120 based on a result of the comparison, and control of the moving object 120 based on the identification of the moving object 120. In accordance with an embodiment, the circuitry 202 may control communication with the moving object 120 based on the identification of the moving object 120. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The processor 204 may comprise suitable logic, circuitry, and interfaces that may be configured to execute instructions stored in the memory 206. In certain scenarios, the processor 204 may be configured to execute the aforementioned operations of the circuitry 202. The processor 204 may be implemented based on a number of processor technologies known in the art. Examples of the processor 204 may be a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), other processors, or a combination thereof.

The memory 206 may comprise suitable logic, circuitry, interfaces, and/or code that may be operable to store a set of instructions executable by the circuitry 202 or the processor 204. The memory 206 may be configured to store the sequence of image frames (e.g., the image 118) captured by the image capturing device 108. The memory 206 may be configured to store the first neural network model 104A that may be pre-trained to detect a moving object 120 from an image (e.g., the image 118) of the moving object 120. Further, the memory 206 may be configured to store the second neural network model 104B that may be pre-trained to determine alphanumeric text within an image or sub-image (e.g., the sub-image 124) of the moving object 120. The alphanumeric text may correspond to the second identification information of the moving object 120. For instance, the alphanumeric text may correspond to the registration number 122A (or tail number) of the aircraft 120A. In some embodiments, the memory 206 may store the first identification information received from the moving object 120. Examples of implementation of the memory 206 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 208 may comprise suitable logic, circuitry, interfaces, and/or code that may be configured to receive an input and provide an output based on the received input. The I/O device 208 may include various input and output devices, which may be configured to communicate with the circuitry 202. Examples of the I/O device 208 may include, but are not limited to, a touch screen, a keyboard, a mouse, a joystick, a display device (for example, the display device 210), a microphone (not shown in FIG. 2), and a speaker (not shown in FIG. 2). The display device 210 may comprise suitable logic, circuitry, and interfaces that may be configured to display an output of the electronic device 102. The display device 210 may be utilized to render a user interface (UI) 212. In some embodiments, the display device 210 may be an external display device associated with the electronic device 102. The display device 210 may be a touch screen which may enable a user to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. In some embodiments, the circuitry 202 may be configured to control the display device 210 to display an identifier (or example flight number or airline name) of the identified moving object 120, via the UI 212.

The network interface 214 may comprise suitable logic, circuitry, interfaces, and/or code that may be configured to enable communication between the electronic device 102, the image capturing device 108, and the server 110, via the communication network 112. In an embodiment, the network interface 214 may also communicatively couple the wireless receiver device 106 with the electronic device 102. The network interface 214 may implement known technologies to support wired or wireless communication with the communication network 112. The network interface 214 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 214 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Long Term Evolution (LTE), Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.120g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS). The identification of a moving object based on a neural network model is further explained, for example, in FIG. 3.

FIG. 3 illustrates an exemplary scenario for implementation of the electronic device of FIG. 2 for a neural network model based identification of a moving object, in accordance with an embodiment of the disclosure. FIG. 3 is explained in conjunction with elements from FIG. 1 and FIG. 2. With reference to FIG. 3, there is shown a scenario 300 that depicts a processing pipeline to identify a moving object based on trained neural network models (such as the first neural network model 104A and the second neural network model 104B). In FIG. 3, for example, a first aircraft 316A and a second aircraft 316B are shown as one or more moving objects captured in a first image 322. It may be noted that the first aircraft 316A and the second aircraft 316B shown in FIG. 3 are merely examples of moving objects. The present disclosure may be also applicable to other types of moving objects such as one or more vehicles. A description of other types of moving objects has been omitted from the disclosure for the sake of brevity.

With reference to FIG. 3, at 302, an image-capture operation is executed. In the image-capture operation, an image-capturing device (for example, the image capturing device 108) may be configured to capture one or more image frames based on the FOV 116 (shown in FIG. 1) of the image capturing device 108. In case of the moving object 120 as an aircraft, the FOV 116 of the image capturing device 108 may be towards the sky from/to where the first aircraft 316A and/or the second aircraft 316B may arrive/depart, a runway of an airport, or a ground area associated with the airport, to further capture the one or more image frames (such as the first image 322) of the aircraft (i.e. moving towards or away from the image capturing device 108). In some embodiments, the circuitry 202 may control the image capturing device 108 to capture the first image 322 based on a distance between the image capturing device 108 and the first aircraft 316A and/or the second aircraft 316B. The distance may be predefined such that the second identification number (i.e. tail number printed or painted on the outer surface of the first aircraft 316A) may be captured in the first image 322 or visible from the image capturing device 108 to an extent. In some embodiments, the circuitry 202 may control one or more imaging parameters (such as, but not limited to, focus, focal length, zoom, exposure, orientation, tilt angle, or position) of the image capturing device 108 based on the predefined distance to further capture the first image 322 of the first aircraft 316A).

In accordance with an embodiment, the circuitry 202 of the electronic device 102 may be configured to receive, from the moving object, first identification information 310 of the moving object (such as the first aircraft 316A). For example, the circuitry 202 may receive the first identification information 310 of the first aircraft 316A from the wireless receiver device 106, which may in-turn receive the first identification information 310 from the first aircraft 316A at regular intervals (say in every few seconds). In accordance with an embodiment, in case the moving object corresponds to an aircraft, the first identification information 310 may correspond to at least one of Automatic Dependent Surveillance-Broadcast (ADS-B) information, Traffic Information Service-Broadcast (TIS-B) information, or Aircraft Communications Addressing and Reporting System (ACARS) message information. In accordance with an embodiment, the first identification information 310 associated with the moving object (e.g., the first aircraft 316A) may include, but is not limited to, a Global Positioning System (GPS) location, an altitude, a speed, or a direction of motion, of the moving object. In some embodiments, the first identification information 310 may include a unique identification number (such as a flight number) of the moving object (i.e. the first aircraft 316A). In case of the moving object, as the vehicle, the first identification information 310 may include a vehicle registration number (i.e. which may be printed on a vehicle license plate).

In accordance with an embodiment, based on the receipt of the first identification information 310, the circuitry 202 may be configured to control the image capturing device 108 to capture the sequence of image frames based on the FOV 116 of the image capturing device 108. The sequence of captured image frames may include the first image 322, which may include the moving object (for example the first aircraft 316A). For example, the first image 322 may be of the moving objects, such as the first aircraft 316A with a first registration number (e.g. “N456AF” as shown in a first region 318A), and the second aircraft 316B with a second registration number (e.g. “N789AF” as shown in a second region 318B). The image capturing device 108 may transmit the sequence of captured image frames, including the first image 322, to the electronic device 102. The circuitry 202 of the electronic device 102 may be configured to process the received image frames, including the first image 322, to identify one or more moving objects (e.g., the first aircraft 316A) from the first image 322 as described, for example, in steps 304, 306, and 308.

In accordance with an embodiment, the circuitry 202 may be configured to determine the one or more imaging parameters of the image capturing device 108 based on the received first identification information 310. Further, the circuitry 202 may be configured to control the image capturing device 108 to capture the first image 322 of the moving object (e.g., the first aircraft 316A) based on the determined one or more imaging parameters. Examples of the one or more imaging parameters may include, but are not limited to, a position parameter, a tilt parameter, a panning parameter, a zooming parameter, an orientation parameter, a type of an image sensor, a pixel size, a lens type, or a focal length for image capture associated with the image capturing device 108. For example, based on the GPS location and altitude of the moving object included in the first identification information 310, the circuitry 202 may be configured determine a physical area in the three-dimensional (3D) space within the FOV 116 that may have a high probability of presence of the moving object. For example, the physical area in the 3D space may include, but is not limited to, an airport area, a runway area, a sky area in the FOV 116 near the airport. The circuitry 202 may be configured to control the image capturing device 108 to pan, zoom, and/or tilt in a certain manner to capture the first image 322 in a direction of the determined physical area in the 3D space within the FOV 116. Alternatively, the circuitry 202 may control the image capturing device 108 to change the FOV 116 of the image capturing device 108 to capture the first image 322 in the direction of the determined physical area in the 3D space. In some embodiments, the circuitry 202 may control the one or more imaging parameters and control the capture of the first image 322 based on a detection of change in the first identification information 310. For example, in case the circuitry 202 detects the change in the GPS location or the altitude of the moving object (i.e. the first aircraft 316A), the circuitry 202 may control the one or more imaging parameters of the image capturing device 108 and further capture the first image 322 of the moving object (i.e. the first aircraft 316A). As shown in FIG. 3, for example, the first image 322 may include multiple moving objects (such as the first aircraft 316A and the second aircraft 316B) captured in the FOV 116 of the image capturing device 108. In some embodiments, the first image 322 may only include one moving object, for example, the first aircraft 316A.

At 304, a sub-image detection operation is executed. In the sub-image detection operation, the circuitry 202 of the electronic device 102 may be configured to apply the trained first neural network model 104A on the captured first image 322 to detect one or more sub-images of one or more moving objects from the first image 322. Examples of the first neural network model 104A may include, but are not limited to, an artificial neural network (ANN), a convolutional neural network (CNN), a CNN-recurrent neural network (CNN-RNN), Region-CNN (R-CNN), Fast R-CNN, Faster R-CNN, a Long Short Term Memory (LSTM) network based RNN, a combination of CNN and ANN, a combination of LSTM and ANN, a gated recurrent unit (GRU)-based RNN, a deep Bayesian neural network, a Generative Adversarial Network (GAN), a deep learning based object detection model, a feature-based object detection model, an image segmentation based object detection model, a blob analysis-based object detection model, a “you look only once” (YOLO) object detection model, or a single-shot multi-box detector (SSD) based object detection model. In an embodiment, each sub-image may include second identification information 312 of the moving object corresponding to the respective sub-image. For example, the circuitry 202 may detect a first sub-image 320A of the first aircraft 316A and a second sub-image 320B of the second aircraft 316B. The first sub-image 320A may include the first region 318A that may include the first registration number (or tail number) of the first aircraft 316A and the second sub-image 320B may include the second region 318B that may include the second registration number (or tail number) of the second aircraft 316B. In accordance with an embodiment, the circuitry 202 may be configured to determine the first region 318A in a sub-image (e.g., the first sub-image 320A) of a moving object (e.g., the first aircraft 316A) based on application of the first neural network model 104A on the captured image (e.g., the first image 322) of the moving object (e.g., the first aircraft 316A). The first registration number or tail number (i.e. “N456AF” as shown in FIG. 3) may be printed or painted on the outer surface of the first aircraft 316A. In some embodiments, in case of multiple moving objects (i.e. the first aircraft 316A and the second aircraft 316B) detected in the captured first image 322, the circuitry 202 may be configured to extract an image of the first aircraft 316A from the first image 322, which may include multiple moving objects. The extracted image of the first aircraft 316A may be considered as the first image 322, as shown in FIG. 3, for further processing by the circuitry 202 of the electronic device 102.

In accordance with an embodiment, the circuitry 202 may determine the first sub-image 320A from the first image 322 or determine the first region 318A from the first sub-image 320A of the moving object (e.g. the first aircraft 316A) based on the application of the first neural network model 104A on the captured first image 322 of the moving object (e.g. the first aircraft 316A). The first neural network model 104A may be trained with a plurality of images (i.e. training dataset) to detect one or more moving objects (such as the first aircraft 316A or the second aircraft 316B). The plurality of images may be stored in the memory 206 or on the server 110. The plurality of images may correspond to the one or more moving objects to be detected. The plurality of images may be several images of moving objects with different visual characteristics (like, but not limited to, color, shape, size, orientation, texture, brightness or sharpness). In some embodiments, the first neural network model 104A may be trained to detect the first sub-image 320A of the first aircraft 316A based on the application of the first neural network model 104A on the first image 322 captured by the image capturing device 108. In other embodiments, the first neural network model 104A may be pretrained to detect the first region 318A (i.e. bounding box) based on the application of the first neural network model 104A on the captured first image 322 or the first sub-image 320A. In accordance with an embodiment, in case of the moving object as the vehicle, the first neural network model 104A may be pre-trained to detect the number plate region (such as, the license plate number 122B of the vehicle 120B shown in FIG. 1).

At 306, second identification information extraction operation is executed. In the second identification information extraction operation, the circuitry 202 may be configured to extract the second identification information 312 of the moving object (e.g., the first aircraft 316A) from a sub-image (e.g., the first sub-image 320A) of the moving object (such as the first aircraft 316A) based on the application of the second neural network model 104B on the sub-image. In some embodiments, the circuitry 202 may extract the second identification information 312 of the moving object (e.g., the first aircraft 316A) from the determined first region 318A based on the application of the second neural network model 104B on the determined first region 318A (i.e. bounding box). The second identification information 312 may include alphanumeric text (“N456AF”, as shown in FIG. 3) within the first sub-image 320A or the first region 318A of the moving object (such as, the first aircraft 316A). For example, the alphanumeric text (i.e., “N456AF”) within the first sub-image 320A or the first region 318A may correspond to the first registration number or the tail number of the first aircraft 316A. Examples of the second neural network model 104B may include, but are not limited to, a connectionist-temporal-classification (CTC)-based deep neural network (DNN) model. In accordance with an embodiment, the CTC-based DNN model may be a combination of a convolutional neural network (CNN) model and a long-short term memory (LSTM)-based recurrent neural network (RNN) model trained based on a CTC model. The second neural network model 104B may be configured to determine text information (such as, the alphanumeric text “N456AF” shown in FIG. 3) based on the application on the second neural network model 104B on the detected first sub-image 320A or the determined first region 318A which may include the text information. The second neural network model 104B may be pre-trained based on a plurality of images (i.e. training dataset) corresponding to different alphanumeric characters or texts of different font styles, font sizes, foreground colors, and/or textures.

At 308, an object identification operation is executed. In the object identification operation, the circuitry 202 may be configured to compare the extracted second identification information 312 of the moving object (e.g., the first aircraft 316A) with the received first identification information 310 of the moving object (e.g., the first aircraft 316A). Thereafter, the circuitry 202 may identify the moving object (e.g., the first aircraft 316A) based on a result of the comparison of the extracted second identification information 312 with the received first identification information 310. In an example, in the case of the first aircraft 316A, the circuitry 202 may receive a call sign of the first aircraft 316A as the first identification information 310 of the first aircraft 316A, via the wireless receiver device 106. Further, the circuitry 202 may extract the alphanumeric text from the first sub-image 320A or the first region 318A of the first aircraft 316A as the second identification information 312 and compare the first identification information 310 with the second identification information 312 to accurately identify or recognize the first aircraft 316A. For example, in case, the first identification information 310 received from the first aircraft 316A is “N456AF” (represented as 324A in FIG. 3), and the extracted second identification information 312 indicates the alphanumeric text as “N456AF” which may be printed or painted inside the first region 318A, then the circuitry 202 may accurately identify or recognize the first aircraft 316A based on a substantial match between the received first identification information 310 and the extracted second identification information 312. In accordance with an embodiment, the identification of the moving object (e.g., the first aircraft 316A) may be considered as successful when the received first identification information 310 of the moving object (i.e., the first aircraft 316A) may be substantially same as the extracted second identification information 312 of the moving object (i.e., first aircraft 316A).

In accordance with an embodiment, the circuitry 202 may be further configured to receive hotlist information associated with a plurality of moving objects, including the moving object (e.g., the first aircraft 316A), from the server 110. The hotlist information may include third identification information 314 of the moving object (e.g., the first aircraft 316A). The circuitry 202 may be configured to identify the moving object (e.g., the first aircraft 316A) based on the received first identification information 310, the extracted second identification information 312, and the third identification information 314 included in the received hotlist information. The received hotlist information may indicate a list of moving objects (such as aircrafts) which may be scheduled to depart or arrive within a particular timeframe (say in next certain minutes). For example, the hotlist information may indicate, but is not limited to, identification information (such as the third identification information 314 as a flight number or tail number) of the moving objects and time of arrival/departure of the moving object. The hotlist information may also indicate information about the moving objects (i.e. aircrafts) which may be expected to arrive/depart or to be captured in the first image 322 by the electronic device 102. In some embodiments, the hotlist information may be stored in the memory 206 of the electronic device 102. The hotlist information may be provided, for example, by the airport traffic controller (ATC) authority. For instance, the third identification information 314 may also include a call sign of the first aircraft 316A based on the scheduled time of arrival or departure of the first aircraft 316A. In accordance with an embodiment, the circuitry 202 may be configured to identify the first aircraft 316A based on a comparison of the first identification information 310 (i.e., call sign or flight number) received from the first aircraft 316A, the second identification information 312 (i.e., alphanumeric text or tail number) extracted from the first sub-image 320A of the first aircraft 316A, and the third identification information 314 (i.e., call sign or flight number) of the first aircraft 316A included in the hotlist information. A comparison or combined analysis based on the first identification information 310, the second identification information 312, and the third identification information 314 may further improve accuracy of the identification of the first aircraft 316A. The combined analysis of the received first identification information 310 and the extracted second identification information 312 or an enhanced analysis of the received first identification information 310, the extracted second identification information 312, and the third identification information 314 in the received/stored hotlist information may be referred as a multi-modal identification of the moving object (e.g., the first aircraft 316A), which provides an improved accuracy in the identification or recognition of the moving object by the disclosed electronic device 102.

In accordance with an embodiment, the circuitry 202 may receive the first identification information 310 of the moving object (e.g., the first aircraft 316A) from the moving object at first time information, which may indicate a particular time (in 12-hour or 24-hour format). Further, the circuitry 202 may determine second time information that may indicate a time of capture of the first image 322 of the moving object (e.g., the first aircraft 316A). In some embodiments, the second time information may indicate a time of extraction of the second identification information 312. Thereafter, the circuitry 202 may be configured to identify the moving object (e.g., the first aircraft 316A) based on a result of comparison of the first time information with the second time information. For example, the circuitry 202 receives, from the first aircraft 316A, the first identification information 310 of the first aircraft 316A at 1:00:00 PM (in HH:MM:SS format) and captures the first image 322 at 1.00.01 pm (i.e. the second time information) say on a same day. Based on the comparison of the first time information with the second time information, the circuitry 202 may determine that the timing of receipt of the first identification information 310 is substantially similar or close to the time of capture of the first image 322 that may correspond to the second identification information 312. Thus, the circuitry 202 may determine that a same moving object (e.g., the first aircraft 316A) that sent the first identification information 310 may be captured in the first image 322 within the particular time frame (say with a second or milliseconds). Thus, a first comparison of the first identification information 310 with the second identification information 312 and a second comparison of the first time information with the second time information performed by the disclosed electronic device 102 may further improve the accuracy of identification/recognition of the moving object (e.g., the first aircraft 316A) on a real-time basis. This improved accuracy in the identification/recognition of the moving object is contrary to the convention solutions where the identification of the moving object is only based on the first identification information 310 received at defined time interval (say in every few seconds). Further, the disclosed electronic device 102 may provide enhanced accuracy in the identification of the moving object even though multiple moving objects (such as multiple aircrafts) arrive/depart within a short duration (say within seconds or minutes).

In accordance with an embodiment, the circuitry 202 may be configured to determine third time information that may correspond to the hotlist information received from the server 110 or retrieved from the memory 206. The third time information may indicate a time of arrival or departure of the moving object (such as the first aircraft 316A) indicated in the hotlist information. The circuitry 202 may be further configured to identify the moving object (e.g., the first aircraft 316A) based on the third time information, in addition to the first time information and the second time information. For example, the third identification information 314 in the hotlist information corresponds to the third time information as 1.02.00 PM (i.e. in HH:MM:SS format). The third time information as 1.02.00 PM may be on the same day of receipt and capture of the first identification information 310 and the second identification information 312, respectively. Based on the comparison of the first time information, the second time information, and the third time information, the circuitry 202 may determine that the received first identification information 310 at the first time information, the extracted second identification information 312 at the second time information, and the third identification information 314 at the third time information corresponds to the same moving object (e.g., the first aircraft 316A). Thus, the circuitry 202 of the disclosed electronic device 102 may perform combined analysis or comparison (i.e. multi-modal) of the first identification information 310, the second identification information 312, and the third identification information 314 on the real-time basis to identify the moving object (e.g., the first aircraft 316A) with enhanced accuracy.

In accordance with an embodiment, the circuitry 202 may be further configured to update the received hotlist information based on the first identification information 310 of the moving object (e.g., the first aircraft 316A). For example, in a scenario where the hotlist information does not include the call sign of the first aircraft 316A or includes an incorrect or partial call sign (or identification number) of the first aircraft 316A, the circuitry 202 may update the hotlist information with the first identification information 310 of the first aircraft 316A or the extracted second identification information 312 of the first aircraft 316A. The circuitry 202 may be further configured to transmit the updated hotlist information to the server 110 or store in the memory 206. Thus, the hotlist information of the plurality of moving objects maintained by the server 110 may be kept updated based on the first identification information 310 received from the particular moving object (e.g., the first aircraft 316A) or the extracted second identification information 312. In some embodiments, the hotlist information may be updated based on the accurate identification of the moving object 120 done based on the combination of the received first identification information 310 and the extracted second identification information 312.

In accordance with an embodiment, the circuitry 202 may be configured to display identification information of the moving object (e.g., flight number or tail number of the first aircraft 316A) on the display device 210 through the UI 212. Further, the circuitry 202 may be configured to update the second neural network model 104B based on the identification of the moving object (e.g., the first aircraft 316A). For example, to update the second neural network model 104B, the circuitry 202 may re-train the second neural network model 104B based on the first image 322 and/or the detected sub-image (e.g., the first sub-image 320A) of the first aircraft 316A as new training dataset images based on which the first aircraft 316A is identified accurately. Further, the circuitry 202 may store the identification information (e.g. “N456AF”) of the first aircraft 316A as an output alphanumeric text of the second neural network model 104B for the first image 322 and/or the detected first sub-image 320A. The circuitry 202 may re-train the second neural network model 104B based on the new training dataset images and the output alphanumeric text. The update or re-training of the second neural network model 104B may further improve the accuracy of the extraction of the alphanumeric text (e.g., the second identification information 312) from the first sub-image 320A of the moving object (e.g., the first aircraft 316A) for subsequent images of moving objects captured by the image capturing device 108 in future. The update of the second neural network model 104B may be useful in scenarios where alphanumeric text associated with the second identification information 312 is partially or substantially correct due to certain factors such as motion blur effect in images (e.g., the first image 322) of the moving object that may be caused by the motion of the moving objects during the capture of the images (e.g., the first image 322), motion of the image capturing device 108, or environment conditions (such as weather conditions like cloudy, rainy, or dusty weather).

In accordance with an embodiment, the circuitry 202 may be further configured to determine the one or more imaging parameters of the image capturing device 108 based on a result of the comparison between the first identification information 310 and the second identification information 312. The determination of the one or more imaging parameters may be further based on the third identification information 314. Thereafter, the circuitry 202 may control the image capturing device 108 to capture a second image of the moving object (e.g., the first aircraft 316A) based on the determined one or more imaging parameters. Examples of the one or more imaging parameters have been enumerated in the image capture operation (FIG. 3, 302) and are omitted here for the sake of brevity. For example, the circuitry 202 may extract the speed and the direction of motion of the moving object (e.g., the first aircraft 316A) from the first identification information 310 and further control the image capturing device 108 to pan, zoom, or tilt in a particular manner to capture the second image such that the second image may also include the alphanumeric text (i.e. tail number) that corresponds to the second identification information 312 of the moving object (e.g., the first aircraft 316A). The circuitry 202 may be further configured to identify the moving object (e.g., the first aircraft 316A) based on the captured second image. In some embodiments, the circuitry may determine a degree of similarity between the received first identification information 310 and the second identification information 312, determine or adjust the one or more imaging parameters of the image capturing device 108 based on the degree of similarity, and further capture the second image of the moving object based on the determined/adjusted one or more imaging parameters. For example, in case the degree of similarity indicates that the first identification information 310 and the second identification information 312 are substantially similar (for example if only 1 alphanumeric character differs), then the circuitry 202 may adjust the one or more imaging parameters (for example, but is not limited to, focus, zoom, tilt, or orientation) of the image capturing device 108 to re-capture the first image 322 or capture the second image of the moving object (i.e. first aircraft 316A), and may again perform the comparison between the received first identification information 310 and re-extracted second identification information 312 to accurately identify the moving object (i.e. first aircraft 316A).

In accordance with an embodiment, post the identification of the moving object (e.g., the first aircraft 316A), the circuitry 202 may be configured to control the moving object (e.g., the first aircraft 316A) based on the identification of the moving object (e.g., the first aircraft 316A). In accordance with an embodiment, the circuitry 202 may be configured to control communication with the moving object (e.g., the first aircraft 316A). For example, based on the identification (e.g., such as, flight number “N456AF”) of the first aircraft 316A, the circuitry 202 may control the communication with the first aircraft 316A. The purpose of the communication may be, but not limited to, alter a speed, altitude, or direction of motion of the first aircraft 316A or provide/receive messages. In accordance with an embodiment, the circuitry 202 may control the wireless receiver device 106 to communicate with the first aircraft 316A using a certain radio frequency or communication protocol known in the art.

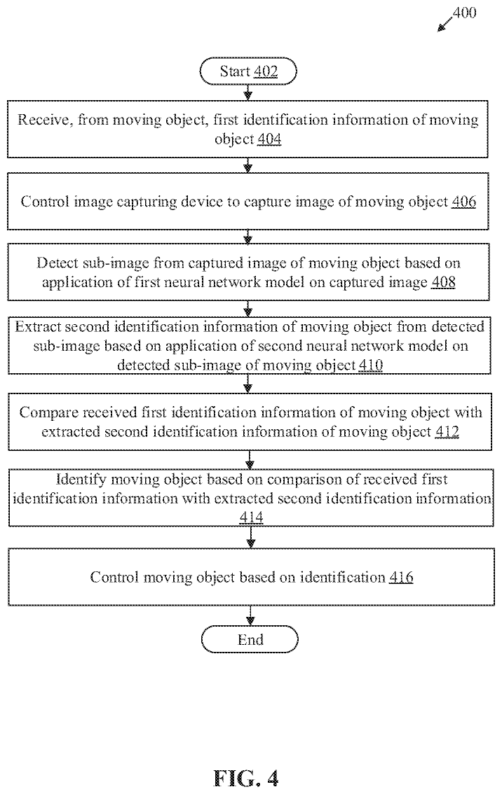

FIG. 4 depicts a flowchart that illustrates an exemplary method for a neural network model based identification of a moving object, in accordance with an embodiment of the disclosure. With reference to FIG. 4, there is shown a flowchart 400. The flow chart is described in conjunction with FIGS. 1, 2, and 3. The exemplary method of the flowchart 400 may be executed by the electronic device 102 or the circuitry 202. The method starts at 402 and proceeds to 404.

At 404, the first identification information 310 of the moving object 120 may be received from the moving object 120. In one or more embodiments, the circuitry 202 may be configured to receive the first identification information 310 of the moving object 120 from the moving object 120, via the wireless receiver device 106. For instance, the wireless receiver device 106 may receive the first identification information 310 at regular defined intervals (e.g., say in every few seconds) from the moving object 120, through the wireless communication link 114. The wireless receiver device 106 may then send the received first identification information 310 to the circuitry 202 as described, for example, in FIGS. 1 and 3.

At 406, the image capturing device 108 may be controlled to capture the image 118 of the moving object 120. In one or more embodiments, the circuitry 202 may be configured to control the image capturing device 108 to capture the sequence of image frames based on the FOV 116 of the image capturing device 108. The sequence of captured image frames may include the image 118 (or the first image 322) of the moving object 120. The circuitry 202 may be configured to receive the capture image 118 of the moving object 120 from the image capturing device 108. The capture of the image 118 (or the first image 322) is described, for example, in FIGS. 1 and 3.

At 408, the sub-image 124 of the moving object 120 may be detected from the image 118 of the moving object 120 based on the application of the first neural network model 104A on the captured image 118. In one or more embodiments, the circuitry 202 may be configured to detect the sub-image 124 of the moving object 120 from the image 118 based on the application of the first neural network model 104A on the image 118. The first neural network model 104A may be trained to detect one or more moving objects based on one or more first images stored corresponding to the one or more moving objects. In an embodiment, the sub-image 124 may correspond to a region that may include the second identification information 312 of the moving object 120. For instance, the sub-image 124 may include the registration number 122A (or tail number) of the aircraft 120A as the second identification information 312. The detection of the sub-image (such as the sub-image 124 or the first sub-image 320A) from the captured image (such as the image 118 or the first image 322) is described, for example, in FIGS. 1 and 3.

At 410, the second identification information 312 of the moving object 120 may be extracted from the detected sub-image 124 of the moving object 120 based on the application of the second neural network model 104B on the detected sub-image 124. In one or more embodiments, the circuitry 202 may be configured to extract the second identification information 312 from the sub-image 124 based on the application of the second neural network model 104B on the sub-image 124. The extraction of the second identification information 312 of the moving object 120 from the sub-image 124 (or the first sub-image 320A) is described, for example, in FIGS. 1 and 3.

At 412, the received first identification information 310 of the moving object 120 may be compared with the extracted second identification information 312 of the moving object 120. In one or more embodiments, the circuitry 202 may be configured to compare the first identification information 310 of the moving object 120 with the second identification information 312 of the moving object 120.

At 414, the moving object 120 may be identified based on the comparison of the received first identification information 310 with the extracted second identification information 312. In one or more embodiments, the circuitry 202 may be configured to identify the moving object 120 based on a result of the comparison of the received first identification information 310 with the extracted second identification information 312. The identification of the moving object 120 is described, for example, in FIGS. 1 and 3.

At 416, the moving object 120 may be controlled based on the identification of the moving object 120. In one or more embodiments, the circuitry 202 may be configured to control the moving object 120 based on the identification of the moving object 120 as described, for example, in FIG. 3. The control may pass to end.

Although the flowchart 400 is illustrated as discrete operations, such as 404, 406, 408, 410, 412, 414, and 416, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer readable medium and/or storage medium, and/or a non-transitory machine readable medium and/or storage medium having stored thereon, a machine code and/or a set of instructions executable by a machine, such as an electronic device, and/or a computer. The set of instructions executable may cause the machine and/or computer to perform the operations that comprise reception of first identification information of a moving object from the moving object. The operations may further include control of an image capturing device to capture an image of the moving object. The operations may further include detection of a sub-image from the captured image of the moving object based on application of a first neural network model on the captured image. The sub-image may include second identification information of the moving object. Further, the first neural network model may be trained to detect one or more moving objects based on one or more first images stored corresponding to the one or more moving objects. The operations may further include extraction of the second identification information of the moving object from the detected sub-image based on application of a second neural network model on the detected sub-image of the moving object. The second neural network model may be trained to determine text information based one or more second images stored corresponding to the text information. The operations may further include comparison of the received first identification information of the moving object with the extracted second identification information of the moving object. Further, the operations may include identification of the moving object based on the comparison of the received first identification information with the extracted second identification information. The operations may further include control of the moving object based on the identification.

Exemplary aspects of the disclosure may include an electronic device (such as the electronic device 102 in FIG. 1) that may include circuitry (such as the circuitry 202 in FIG. 2) and a memory (such as the memory 206 in FIG. 2). The memory 206 of the electronic device 102 may be configured to store a first neural network model (such as the first neural network model 104A in FIG. 1) and a second neural network model (such as the second neural network model 104B in FIG. 1). The circuitry 202 of the electronic device 102 may be configured to receive first identification information of a moving object (such as the moving object 120 in FIG. 1) from the moving object 120. The circuitry 202 may be configured to control an image capturing device (such as the image capturing device 108 in FIG. 1) to capture an image (such as the image 118 in FIG. 1) of the moving object 120. Further, the circuitry 202 may be configured to detect a sub-image (such as the sub-image 124 in FIG. 1) from the captured image 118 of the moving object 120 based on application of the first neural network model 104A on the captured image 118. The sub-image 124 may include second identification information of the moving object 120. Further, the first neural network model 104A may be trained to detect one or more moving objects based on one or more first images stored corresponding to the one or more moving objects. The circuitry 202 may be further configured to extract the second identification information of the moving object 120 from the detected sub-image 124 based on application of the second neural network model 104B on the detected sub-image 124 of the moving object 120. The second neural network model 104B may be trained to determine text information based one or more second images stored corresponding to the text information. The circuitry 202 may be configured to compare the received first identification information of the moving object 120 with the extracted second identification information of the moving object 120. Further, the circuitry 202 may be configured to identify the moving object 120 based on the comparison of the received first identification information with the extracted second identification information. The circuitry 202 may be further configured to control of the moving object based on the identification.

In an embodiment, the identification of the moving object 120 may be successful based on a determination that the received first identification information is same as the extracted second identification information. In an embodiment, the circuitry 202 may be configured to control communication with the moving object 120 based on the identification of the moving object 120. In an embodiment, the moving object 120 may correspond to at least one of a moving vehicle (e.g., the vehicle 120B) or a moving aircraft (e.g., the aircraft 120A). Each of the first identification information and the second identification information may correspond to one of a license plate number of the moving vehicle (e.g., the license plate number 122B of the vehicle 120B) or a tail number of the moving aircraft (e.g., the registration number 122A of the aircraft 120A).

Examples of the first neural network model 104A may include, but are not limited to, an artificial neural network (ANN), a convolutional neural network (CNN), a CNN-recurrent neural network (CNN-RNN), Region-CNN (R-CNN), Fast R-CNN, Faster R-CNN, a Long Short Term Memory (LSTM) network based RNN, a combination of CNN and ANN, a combination of LSTM and ANN, a gated recurrent unit (GRU)-based RNN, a deep Bayesian neural network, a Generative Adversarial Network (GAN), a deep learning based object detection model, a feature-based object detection model, an image segmentation based object detection model, a blob analysis-based object detection model, a “you look only once” (YOLO) object detection model, or a single-shot multi-box detector (SSD) based object detection model. Further, the second neural network model 104B may include, but is not limited to, a connectionist-temporal-classification (CTC)-based deep neural network (DNN) model.

In accordance with an embodiment, the circuitry 202 may be configured to determine a region in the sub-image 124 of the moving object 120 based on the application of the first neural network model 104A on the captured image 118 of the moving object 120. Thereafter, the circuitry 202 may be configured to extract the second identification information of the moving object 120 from the determined region based on the application of the second neural network model 104B on the determined region. In an embodiment, the circuitry 202 may be further configured to update the second neural network model 104B based on the comparison of the received first identification information of the moving object 120 with the extracted second identification information of the moving object 120.

In an embodiment, the first identification information may include, but is not limited to, at least one of an identification number of the moving object 120, a Global Positioning System (GPS) location of the moving object 120, an altitude of the moving object 120, a speed of the moving object 120, or a direction of motion of the moving object 120. The circuitry 202 may be configured to determine one or more imaging parameters of the image capturing device 108 based on the received first identification information. Thereafter, the circuitry 202 may be configured to control the image capturing device 108 to re-capture the image 118 of the moving object 120 based on the determined one or more imaging parameters.

In accordance with an embodiment, the circuitry 202 may be configured to determine the one or more imaging parameters of the image capturing device 108 based on a result of the comparison of the received first identification information with the extracted second identification information. Thereafter, the circuitry 202 may be configured to control the image capturing device 108 to capture a second image of the moving object 120 based on the determined one or more imaging parameters. Further, the circuitry 202 may identify the moving object 120 based on the captured second image. Examples of the one or more imaging parameters of the image capturing device 108 may include, but are not limited to, a position parameter, a tilt parameter, a panning parameter, a zooming parameter, an orientation parameter, a type of an image sensor, a pixel size, a lens type, or a focal length for image capture, associated with the image capturing device 108.

In some embodiments, the circuitry 202 may be configured to receive, from a server (such as the server 110 in FIG. 1), hotlist information associated with a plurality of moving objects which may include the moving object 120. The hotlist information may include third identification information associated with the moving object 120. Thereafter, the circuitry 202 may be configured to identify the moving object 120 based on the received first identification information, the extracted second identification information, and the third identification information. In an embodiment, the circuitry 202 may be configured to update the received hotlist information based on the identification of the moving object 120. Further, the circuitry 202 may be configured to transmit the updated hotlist information to the server 110.

In some embodiments, the circuitry 202 may be further configured to receive the first identification information from the moving object 120 at first time information. The circuitry 202 may be configured to determine second time information which may indicate a time of the capture of the image 118 of the moving object 120. Further, the circuitry 202 may be configured to identify the moving object 120 based on a comparison of the first time information and the second time information. In addition, the circuitry 202 may be further configured to determine third time information corresponding to hotlist information received from the server 110. Further, the circuitry 202 may be configured to identify the moving object 120 based on the first time information, the second time information, and the third time information.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. An electronic device, comprising:
circuitry configured to:
receive, from a moving object, first identification information of the moving object;
control an image capturing device to capture an image of the moving object;
detect a sub-image from the captured image of the moving object based on application of a first neural network model on the captured image, wherein the sub-image includes second identification information of the moving object, and wherein the first neural network model is trained to detect one or more moving objects based on one or more first images stored corresponding to the one or more moving objects;
extract the second identification information of the moving object from the detected sub-image based on application of a second neural network model on the detected sub-image of the moving object, wherein the second neural network model is trained to determine text information based one or more second images stored corresponding to the text information;
compare the received first identification information of the moving object with the extracted second identification information of the moving object;
identify the moving object based on the comparison of the received first identification information with the extracted second identification information; and
control the moving object based on the identification.

2. The electronic device according to claim 1, wherein the circuitry is further configured to control communication with the moving object based on the identification of the moving object.

3. The electronic device according to claim 1, wherein the first neural network model comprises at least one of an artificial neural network (ANN), a convolutional neural network (CNN), a CNN-recurrent neural network (CNN-RNN), Region-CNN (R-CNN), Fast R-CNN, Faster R-CNN, a Long Short Term Memory (LSTM) network based RNN, a combination of CNN and ANN, a combination of LSTM and ANN, a gated recurrent unit (GRU)-based RNN, a deep Bayesian neural network, a Generative Adversarial Network (GAN), a deep learning based object detection model, a feature-based object detection model, an image segmentation based object detection model, a blob analysis-based object detection model, a “you look only once” (YOLO) object detection model, or a single-shot multi-box detector (SSD) based object detection model.

4. The electronic device according to claim 1, wherein the second neural network model comprises a connectionist-temporal-classification (CTC)-based deep neural network (DNN) model.

5. The electronic device according to claim 1, wherein the circuitry is further configured to:
determine a region in the sub-image of the moving object based on the application of the first neural network model on the captured image of the moving object; and
extract the second identification information of the moving object from the determined region based on the application of the second neural network model on the determined region.

6. The electronic device according to claim 1, wherein the circuitry is further configured to update the second neural network model based on the comparison of the received first identification information of the moving object with the extracted second identification information of the moving object.

7. The electronic device according to claim 1, wherein the moving object corresponds to at least one of a moving vehicle or a moving aircraft, and wherein each of the first identification information and the second identification information corresponds to one of a license plate number of the moving vehicle or a tail number of the moving aircraft.

8. The electronic device according to claim 1, wherein the first identification information comprises at least one of an identification number of the moving object, a Global Positioning System (GPS) location of the moving object, an altitude of the moving object, a speed of the moving object, or a direction of motion of the moving object.

9. The electronic device according to claim 8, wherein the circuitry is further configured to:
determine one or more imaging parameters of the image capturing device based on the received first identification information; and
control the image capturing device to re-capture the image of the moving object based on the determined one or more imaging parameters.

10. The electronic device according to claim 1, wherein the circuitry is further configured to:
determine one or more imaging parameters of the image capturing device based on a result of the comparison;
control the image capturing device to capture a second image of the moving object based on the determined one or more imaging parameters; and
identify the moving object based on the captured second image.

11. The electronic device according to claim 10, wherein the one or more imaging parameters of the image capturing device comprise at least one of a position parameter, a tilt parameter, a panning parameter, a zooming parameter, an orientation parameter, a type of an image sensor, a pixel size, a lens type, or a focal length for image capture associated with the image capturing device.

12. The electronic device according to claim 1, wherein the circuitry is further configured to:
receive, from a server, hotlist information associated with a plurality of moving objects which includes the moving object, wherein the hotlist information includes third identification information associated with the moving object; and
identify the moving object based on the received first identification information, the extracted second identification information, and the third identification information.

13. The electronic device according to claim 12, wherein the circuitry is further configured to:
update the received hotlist information based on the identification of the moving object; and
transmit the updated hotlist information to the server.

14. The electronic device according to claim 1, wherein the identification of the moving object is successful based on a determination that the received first identification information is same as the extracted second identification information.

15. The electronic device according to claim 1, wherein the circuitry is further configured to:
receive the first identification information from the moving object at first time information;
determine second time information which indicates a time of the capture of the image of the moving object; and
identify the moving object based on a comparison of the first time information and the second time information.

16. The electronic device according to claim 15, wherein the circuitry is further configured to:
determine third time information corresponding to hotlist information received from a server, wherein the hotlist information is associated with a plurality of moving objects which includes the moving object, and wherein the hotlist information includes third identification information associated with the moving object; and
identify the moving object based on the first time information, the second time information, and the third time information.

17. A method, comprising:
in an electronic device:
receiving, from a moving object, first identification information of the moving object;
controlling an image capturing device to capture an image of the moving object;
detecting a sub-image from the captured image of the moving object based on application of a first neural network model on the captured image, wherein the sub-image includes second identification information of the moving object, and wherein the first neural network model is trained to detect one or more moving objects based on one or more first images stored corresponding to the one or more moving objects;
extracting the second identification information of the moving object from the detected sub-image based on application of a second neural network model on the detected sub-image of the moving object, wherein the second neural network model is trained to determine text information based one or more second images stored corresponding to the text information;
comparing the received first identification information of the moving object with the extracted second identification information of the moving object;
identifying the moving object based on the comparison of the received first identification information with the extracted second identification information; and
controlling the moving object based on the identification.

18. The method according to claim 17, further comprising updating the second neural network model based on the comparison of the received first identification information of the moving object with the extracted second identification information of the moving object.

19. The method according to claim 17, wherein the moving object corresponds to at least one of a moving vehicle or a moving aircraft, and wherein each of the first identification information and the second identification information corresponds to one of a license plate number of the moving vehicle or a tail number of the moving aircraft.

20. A non-transitory computer-readable medium having stored thereon, computer-executable instructions that when executed by an electronic device, causes the electronic device to execute operations, the operations comprising:
receiving, from a moving object, first identification information of the moving object;
controlling an image capturing device to capture an image of the moving object;
detecting a sub-image from the captured image of the moving object based on application of a first neural network model on the captured image, wherein the sub-image includes second identification information of the moving object, and wherein the first neural network model is trained to detect one or more moving objects based on one or more first images stored corresponding to the one or more moving objects;
extracting the second identification information of the moving object from the detected sub-image based on application of a second neural network model on the detected sub-image of the moving object, wherein the second neural network model is trained to determine text information based one or more second images stored corresponding to the text information;
comparing the received first identification information of the moving object with the extracted second identification information of the moving object;
identifying the moving object based on the comparison of the received first identification information with the extracted second identification information; and
controlling the moving object based on the identification.
